(19) United States
(12) Patent Application Publication
(10) Pub. No.: US 2026/0003644 A1
(43) Pub. Date: Jan. 1, 2026

(54) ASYNCHRONOUS FUNCTION EXECUTORS UTILIZING WORK UNIT STACKS

(71) Applicant: Microsoft Technology Licensing, LLC, Redmond, WA (US)

(72) Inventor: Vassili BYKOV, San Jose, CA (US)

(73) Assignee: Microsoft Technology Licensing, LLC, Redmond, WA (US)

(21) Appl. No.: 18/754,968

(22) Filed: Jun. 26, 2024

(51) Int. Cl. G06F 9/448; G06F 9/48

(52) U.S. Cl. CPC G06F 9/4484; G06F 9/4881

(57) ABSTRACT

Implementations for executing asynchronous functions using a work unit stack executor on a data processing unit are provided. One aspect includes a computing system for executing asynchronous functions using a work unit (WU) stack executor, the computing system comprising a data processing unit including a plurality of programmable processing cores configured to execute an asynchronous function by performing a call to the asynchronous function, creating a future corresponding to the asynchronous function, creating a WU stack, creating the WU stack executor on the WU stack to execute the future and sending a WU to start the WU stack executor.

### BACKGROUND

In the conventional programming model implemented by traditional central processing units (CPUs), a program is generally defined as a set of functions. A program includes a dedicated function, often called “main,” which represents the program as a whole. Program execution begins with a call to the main function and completes when the main function exits. Within the main function, calls to other functions can be performed. The main function and the functions called by the main function (and the functions called by those functions, etc.) define the program and can be referred to as the call graph or call tree. The execution of the program generally proceeds as a series of function calls and returns, and, at any moment in time, there is a function currently executing. This continuous execution activity, backed by a stack, can be referred to as a thread.

In many computer architectures, multiple threads are executed at the same time (a strategy referred to as multi-threading, multi-tasking, or concurrency). With multi-threading, efficient utilization of CPU resources is an important consideration and challenge. For example, threads performing different operations can take different amounts of time (CPU cycles). Oftentimes, a thread can be idle while waiting for an operation of another thread to be completed. In such cases, available CPU computing power can be better utilized by placing the idle thread on hold and switching to executing a thread that is ready to run in the meantime. In addition to being idle, a thread may lose the CPU's “attention” in a process called preemption. Preemption can occur when a busy thread that has been running is stopped in the middle of its operations, and the CPU switches to a different thread. This can prevent a busy thread from occupying the CPU's resources (potentially indefinitely) while no other thread can make progress.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Implementations for executing asynchronous functions using a work unit stack executor on a data processing unit are provided. One aspect includes a computing system for executing asynchronous functions using a work unit (WU) stack executor, the computing system comprising a data processing unit comprising a plurality of programmable processing cores configured to execute an asynchronous function by: performing a call to the asynchronous function; creating a future corresponding to the asynchronous function; creating a WU stack; creating the WU stack executor on the WU stack to execute the future; and sending a WU to start the WU stack executor.

### BRIEF DESCRIPTION OF THE DRAWINGS

FIG. 1 shows a block diagram illustrating an example system implementing nodes including data processing units.

FIG. 2 shows a block diagram illustrating an example data processing unit that can be implemented in a data processing unit programming model, such as the system depicted in FIG. 1.

FIG. 3 shows a diagram illustrating an example WU stack data structure that can be implemented in a data processing unit programming model, such as the system depicted in FIG. 1.

FIG. 4 shows a flow diagram describing an example method for implementing a work unit stack executor capable of executing an asynchronous function on a data processing unit.

FIG. 5 shows a diagram of an example implementation where memory for a future is allocated on a work unit stack.

FIG. 6 shows a diagram of an example implementation where memory for a future is allocated on heap memory.

FIG. 7 schematically shows a non-limiting embodiment of a computing system that can enact one or more of the methods and processes described above.

### DETAILED DESCRIPTION

Traditional CPU programming and architectures are well-established and perform well in many systems, especially in systems where the number of concurrently executing threads is relatively low (e.g., consumer-class devices). On the other hand, data-intensive systems such as storage and network datacenter nodes typically perform a very large number of concurrent activities (e.g., up to and above a thousand). This generally results in architecture designs implementing large numbers of concurrent threads. However, concurrency comes with performance overheads, and implementing larger numbers of concurrent threads can result in performance inefficiency due to the scaled overhead costs. Examples of performance overhead costs include the cost of context switching and the cost of data locking.

Different types of programming models have been contemplated to alleviate performance overhead costs from various sources. One such model includes the use of data processing units (DPUs), which are specialized processors that can advantageously be implemented for data-intensive systems. The DPU programming model can allow for performing a large number (e.g., up to and above a million) of concurrent activities without relying on the traditional thread mechanisms, thus avoiding the overhead costs associated with such mechanisms. Unlike the traditional thread model, a program is not defined as a call tree in the DPU programming model. Instead, the DPU programming model implements work units (WUs), which are units of functionality similar to a function call. A WU invokes a block of executable code, referred to as a WU handler, to perform an operation. Unlike a function, a WU handler cannot call another WU handler, wait for it to produce a result, and then continue the execution using the result. Sending a WU is a one-way request—i.e., when a WU handler sends a WU, the sender continues to execute without waiting.

Although the DPU programming model avoids some of the performance overheads associated with threads, it introduces new challenges. For example, the DPU programming model forgoes the convenience and composability of the traditional call-and-return model. To address the composability problem, the DPU runtime software can implement a mechanism called the WU stack. Briefly, a WU stack is a queue of WUs representing future work. The WU stack can be implemented with operations to add more work to the queue (referred to as a “push”) and to retrieve and send the most recently added WU (referred to as “pop and send”). While WU stacks enable composability, programming for the DPU remains significantly laborious and error-prone as a program expressed as a set of WU handlers does not have the same natural form as a traditional program. Its structure does not directly and intuitively reflect the logic that it implements.

In view of the observations above, the present disclosure describes techniques for adapting asynchronous (async) functions to DPU programming using a WU stack executor. Async functions are a facility provided by various programming languages (e.g., Rust, Swift, JavaScript, etc.) and are generally functions that can express multiple concurrent activities as “logical threads” executable by a single CPU thread. Adaptation of async functions to the DPU programming model provides an intuitive transition as async functions can run in “chunks” between await points, resembling the way a WU-based program is executed in chunks (the WU handlers). Thus, code in an async function can be executed as a set of WU handlers while retaining its natural form, addressing some of the challenges of WU stack programming.

“Asynchronous” function execution strategy differs among programming languages. In some languages, e.g. the Rust programming language, an asynchronous function is executed by a component called the executor. An executor may be implemented in different ways to realize different execution strategies. In some implementations, execution of a given async function on a DPU begins with a WU handler calling the async function to execute. The function produces a “future” that represents the computation expressed by the function that will happen in the future. The WU handler then creates a WU stack executor and gives it the future to execute. A WU stack is created to be used by the WU stack executor, and the WU stack executor is prepared to use the WU stack to execute the future produced previously. Then, a WU is sent to start the WU stack executor to execute the async function. Execution of the WU handler that contained the launch expression continues, executing code that follows that launch expression. This can occur independently of the execution of the async function.

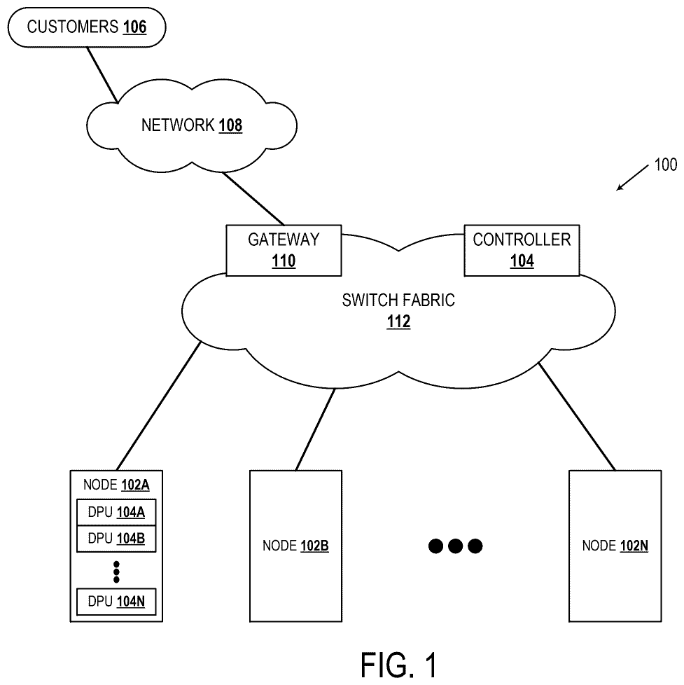

Turning now to the figures, implementations of WU stack executors for executing async functions are described in further detail. WU stack executors and WU stacks can be implemented in DPU programming models utilizing one or more DPUs. FIG. 1 shows a block diagram illustrating an example system 100 implementing a DPU programming model utilizing nodes 102 containing DPUs 104. As shown, the example system 100 illustrates an operating environment for providing applications and services to customers 106 (e.g., individuals, collective entities, etc.), which is accessible via a network 108 and a gateway device 110. Examples of such services can include data storage, virtual private networks, file storage services, data mining services, scientific- or super-computing services, etc.

The network 108 can be, for example, a content/service provider network, a data center wide-area network (DC WAN), a private network, etc. The network 108 can be coupled to one or more networks administered by other providers and may thus form part of a large-scale public network infrastructure, e.g., the Internet. The example system 100 implements a plurality of nodes 102 interconnected through a switch fabric 112. The switch fabric 112 can be implemented in various ways. In some implementations, the nodes 102 are interconnected through the switch fabric 112 via Ethernet links. The example system 100 further includes a software-defined networking (SDN) controller 114 that provides a high-level controller for configuring and managing the routing and switching infrastructure. Other components not shown in FIG. 1 can also be implemented in the example system 100. For example, the example system 100 can further include host infrastructure equipment, networking and storage systems, redundant power supplies, environmental controls, etc.

In the depicted example of FIG. 1, one or more of the nodes 102 are implemented to include one or more DPUs 104. Nodes 102 can be implemented as logical units providing various services and capabilities. For example, nodes 102 can include one or more of a compute node, a storage node, etc. The DPUs 104 can provide, for example, various data processing tasks, such as networking, security, and storage, as well as related work acceleration, distribution and scheduling, and other such tasks. In some implementations, the DPUs 104 may be used in conjunction with application processors to offload any data-processing intensive tasks and free the application processors for computing-intensive tasks. In implementations where control plane tasks are relatively minor compared to the data-processing intensive tasks, the DPUs 104 can be implemented to take the place of the application processors.

As described above, implementing a DPU programming model using DPUs, such as in the example system 100 of FIG. 1, provides several technical advantages. For example, the use of DPUs allows for performing a large number of concurrent activities without relying on traditional thread mechanisms, allowing for the system to avoid certain overheads. One type of such performance overheads includes the cost of context switching. Current CPU architectures generally include sophisticated optimizations, such as instruction pipelining and branch prediction, to improve the execution speed by looking ahead in the code to be executed to prepare for future instructions. They can also implement a memory caching scheme in which a block of memory content around a recently accessed location is temporarily stored in internal CPU memory, allowing faster access in the likely chance that the next memory access happens close to that previous location. Both of these optimization schemes assume that the CPU will continue executing its current code. However, when a thread switch happens, that assumption breaks down as the CPU starts from scratch on the code it has not seen. With more frequent thread switching, the performance cost of context switching overhead becomes higher.

Another type of overhead includes the cost of data locking associated with preemptive multi-tasking. With preemption, a thread can be stopped at any point within a function call. If the thread was in the middle of updating a data structure when it was stopped, another thread looking at the same data can find the data in an inconsistent state. To avoid such situations, systems with preemption typically rely on data locks (different designs of which with different properties can be referred to as monitors, mutexes, or semaphores) that allow a program to enforce that only one thread at a time can access shared data. Locking and unlocking come with performance cost overhead. As the number of threads using locks increases, the overhead cost associated with the usage of such data locks also increases.

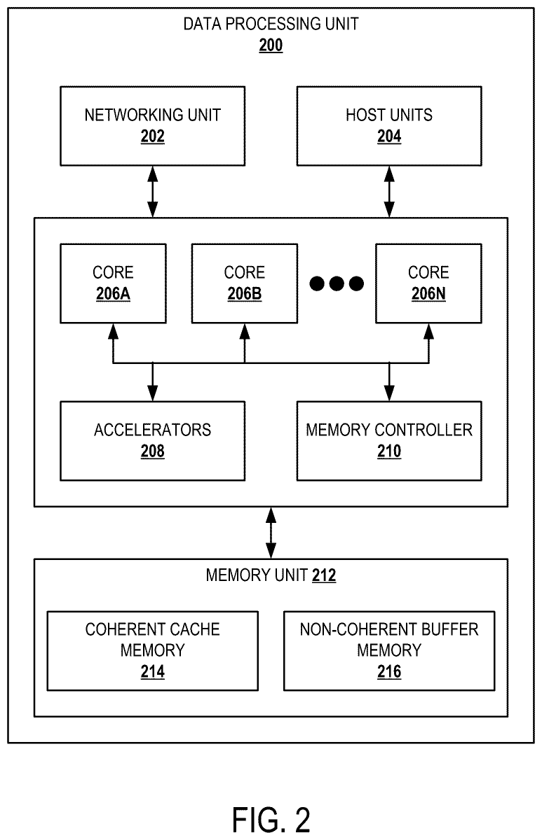

FIG. 2 shows a block diagram illustrating an example data processing unit 200 that can be implemented in a DPU programming model. The example DPU 200 can be implemented as, for example, one of the DPUs 104 depicted in FIG. 1. The example DPU 200 generally represents a hardware chip implemented in digital logic circuitry and can be communicatively coupled to various other devices, including but not limited to a CPU, a graphics processing unit (GPU), a network device, a server device, random access memory, storage media (e.g., solid state drives (SSDs)), a data center fabric, etc. via any wired or wireless communication media (e.g., PCI-e, Ethernet, etc.).

The example DPU 200 includes a networking unit 202, one or more host units 204, a plurality of programmable processing cores 206, one or more accelerators 208, a memory controller 210, and a memory unit 212. As shown, each component can be communicatively coupled to the other components. In the depicted example, the memory unit 212 includes two types of memory or memory devices, namely coherent cache memory 214 and non-coherent buffer memory 216. Various other configurations of the memory unit 212 can be implemented. In some implementations, the DPU 200 includes one or more high bandwidth interfaces for connectivity to off-chip external memory (not illustrated in FIG. 2).

One or more of the host units 204 can be implemented to support one or more host interfaces (e.g., PCI-e ports) for connectivity to an application processor (e.g., an x86 processor of a server device or a local CPU or GPU of the device hosting the DPU 200) or a storage device (e.g., an SSD). One or more of the accelerators 208 can be implemented to perform acceleration for various data-processing functions, such as look-ups, matrix multiplication, cryptography, compression, regular expressions, etc. For example, the accelerators 208 can include hardware implementations of look-up engines, matrix multipliers, cryptographic engines, compression engines, regular expression interpreters, etc.

The memory controller 210 can be implemented to control access to the memory unit 212 by the programmable processing cores 206, the networking unit 202, and/or external devices (e.g., network devices, servers, external storage devices, etc.). The memory controller 210 can be configured to perform a number of operations to perform memory management. For example, the memory controller 210 can be configured to map accesses from one of the processing cores 206 to either the coherent cache memory 214 or the non-coherent buffer memory 216. In some implementations, the memory controller 214 maps the accesses based on one or more of an address range, an instruction or an operation code within the instruction, a special access, or a combination thereof.

The example DPU 200 can be configured and designed for various applications. For example, the various components depicted in the example DPU 200 can be implemented to enable a high performance, hyper-converged device offering network, storage, data processing, and input/output hub capabilities. In some implementations, the DPU 200 is implemented to act as a combination of a switch/router and a number of network interface cards. For example, the networking unit 202 may be configured to receive one or more data packets from and to transmit one or more data packets to one or more external devices, e.g., network devices. The networking unit 202 may perform network interface card functionality, packet switching, and the like, and may use large forwarding tables and offer programmability. The networking unit 202 may expose Ethernet ports for connectivity to a network.

The programmable processing cores 206 can be implemented in various ways. Each of the programmable processing cores 206 can be programmed to process one or more events or activities related to a given data packet such as, for example, a networking packet or a storage packet. Each of cores 206 may be programmable using a high-level programming language, e.g., C, C++, Rust, or the like. In the depicted example, the DPU 200 is generally shown to include an N number of programmable processing cores 206A-206N. Any number of programmable processing cores 206 can be utilized. In some implementations, the DPU 200 includes at least six programmable processing cores 206. Different architectures can be implemented for the processing cores 206. For example, the programmable processing cores 206 can include one or more of a MIPS (microprocessor without interlocked pipeline stages) core, an ARM (advanced RISC (reduced instruction set computing) machine) core, a PowerPC (performance optimization with enhanced RISC-performance computing) core, a RISC-V (RISC five) core, and/or a CISC (complex instruction set computing or x86) core.

In some implementations, the programmable processing cores 206 can process a plurality of events related to each data packet of one or more data packets that are received by networking unit 202 and/or host units 204 in a sequential manner using one or more work units. For example, in processing the plurality of events related to each data packet, a first one of the plurality of cores 206 (e.g., core 206A) can process a first event of the plurality of events and can provide to a second one of plurality of cores 206 (e.g., core 206B) a first WU of the one or more WUs. The second core may process a second event of the plurality of events in response to receiving the first WU from the first core.

In general, a WU is executed by one of the DPU cores, which can also be referred to as a virtual processor (VP). A “WU send” identifies the WU handler function to execute and the destination VP on which it is to be executed. If the destination VP is idle, the WU handler can execute immediately. Otherwise, it can be added to the queue of WUs maintained by the VP to be executed at a later time. The DPU can be configured to follow a run-to-completion policy. In such implementations, once a VP starts executing a WU handler, it continues until the entire handler body has been executed. This allows overhead-free access to shared data structures, unlike in traditional preemptive systems. Instead of relying on locking, the program simply arranges that any access to the given structure is done by a dedicated VP, which can enforce that only one piece of code at a time can read and modify that data.

WUs can be implemented to include sets of data exchanged between processing cores 206 and networking unit 202 and/or host units 204, where each WU may represent one or more of the events related to a given data packet of a stream. In some implementations, a WU is a container that is associated with a stream state and can be used to describe (point to) data within a stream (stored). For example, WUs can be implemented to dynamically originate within a peripheral unit coupled to the multi-processor system (e.g. injected by a networking unit, a host unit, or a solid-state drive interface), or within a processor itself, in association with one or more streams of data, and terminate at another peripheral unit or another processor of the system. The WU is associated with an amount of work that is relevant to the entity executing the WU for processing a respective portion of a stream.

DPU architectures, work units, and implementations of such are described in further detail in U.S. Pat. No. 11,303,472 filed Jul. 10, 2018, entitled “DATA PROCESSING UNIT FOR COMPUTE NODES AND STORAGE NODES,” the entire content of which is incorporated herein by reference.

In the traditional programming model, it is implied that a function returns to the caller. However, in the WU model, a WU handler ends without implicitly starting any follow-up work. Any such work is explicitly started by the handler, for example, by sending a specific hardcoded “continuation WU”. This hardcoding creates a composability problem. Because the follow-up workflow is hardcoded into the handler, the handler cannot be reused in the context of a different workflow. To solve the composability problem, the DPU runtime software provides a mechanism called the WU stacks. A WU stack can be implemented as a queue of WUs representing future work. The operation implemented by a WU handler can be included into different workflows, because the continuation WU is determined outside of the handler. The WU stack can be viewed as a stack of continuations used in addition to a typical program stack of the operating system executed by the network device. Such data structures provide an efficient means for composing program functionality that can enable seamless moving of program execution between cores of a multiple core system. As described herein, a WU stack can be implemented as a data structure that provides certain technical benefits, such as helping manage an event driven, run-to-completion programming model of an operating system executed by a multiple core processor system. Another technical benefit of the WU stack data structure architecture is to enable use of familiar programming constructs (e.g., call/return and long-lived stack-based variables) within an event-driven execution model so commonly used within network devices.

A WU data structure itself is a building block in a WU stack and can be used to compose a processing pipeline and services execution by the multiple core processor system. As described herein, the WU stack is a data structure to help manage the event driven, run-to-completion programming model for software functions or event handlers executed by a device, which may be components for processing packets of information within network devices, compute nodes, storage devices, etc. The WU stack structure flows along with a respective packet and carries state, memory, and/or other information in auxiliary variables to allow program execution for processing the packet to transition between cores. In this way, the configuration and arrangement of the WU stack are separate from the program stack maintained by the operating system, allowing program execution to be moved between processing cores and thereby facilitating high-speed, event-driven stream processing. A frame structure utilized by the WU stack can be maintained in software and can be mapped directly to hardware, such as, for example, to particular cores for execution.

A WU stack frame can be described as a continuation WU in which a portion of the WU, e.g., the frame argument, can be used to identify a subsequent processing stage for the WU once the WU is executed. The WU stack may be used in addition to a typical program stack of a control plane operating system executed by a DPU (or other device) as an efficient means of moving program execution between processing cores for processing stream data. More specifically, the program stack may control code points for execution of computations while the WU stack helps facilitate flow of the program execution between processing cores. The run-to-completion execution model of the data plane operating system may thus be viewed as an underlying environment for execution of a chain of WU event handlers and/or hardware accelerators making use of the WU stack. To provide dynamic composition of WU handlers, continuations from one handler to the next can be resolved at runtime rather than statically. Moreover, a frame pointer argument of a WU handler function points directly to the continuation WU in order to invoke the subsequent handler. This construct may be used to simplify implementation of a number of familiar, higher-level semantics, including pipelining and call/return, for the programmer using an event-driven control plane while providing a powerful run-to-completion data plane with specialized WU stack constructs for efficient stream processing.

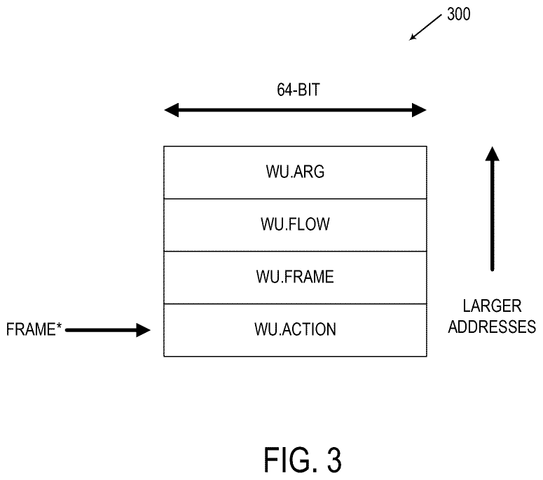

FIG. 3 shows a diagram illustrating an example WU stack data structure 300. The WU stack data structure 300 can represent, for example, a WU stack frame pointed to by a WU. The example WU stack frame 300 includes each of the 64-bit (8-byte) words of a WU arranged in a 64-bit wide stack with larger addresses arranged in ascending order. In the depicted example, the 64-bit words include wu.action, wu.frame, wu.flow, and wu.arg. An external frame pointer points to the lowest address of the example WU stack data structure 300.

WU stack data structures and their implementations are described in further detail in U.S. Pat. No. 10,841,245 filed Nov. 20, 2018, entitled “WORK UNIT STACK DATA STRUCTURES IN MULTIPLE CORE PROCESSOR SYSTEM FOR STREAM DATA PROCESSING,” the entire content of which is incorporated herein by reference.

While the WU stack architecture can provide composability, programming for the DPU remains laborious and error-prone. Generally, in a DPU programming model, a program would be manually converted into a form that can be executed using the WU stack. In such a form, what could logically be a simple linear sequence of operations can be split into multiple apparently unrelated functions implementing individual work units (also referred to as WU handlers) and structures for sharing data between the WU handlers. However, this can obscure the original logic and lead to multiple problems. In a more specific example, the coding of a simple loop can present multiple challenges. Generally, WU handlers run to completion. Once a VP starts executing the body of the handler, no other work is done by the VP until control reaches the end of the handler. As such, buggy code could effectively disable a VP if it entered an infinite loop. To protect against such scenarios, some implementations include a “watchdog” service detecting and terminating long-running WU handlers. As a consequence, a WU handler in general may not use simple looping code, except for cases when it's guaranteed that the loop always finishes quickly. To express a loop in a DPU-friendly way, it should be implemented as a WU handler, with each iteration performed as an individual WU send. Such a loop may run for an arbitrarily large number of iterations without triggering the watchdog. Given these issues, programmer productivity can be a challenge in the implementation of a DPU programming model, and the likelihood of introducing bugs at any stage of the program lifecycle dramatically increases.

The present disclosure provides implementations that utilize the concept of asynchronous code to address the major challenges of “raw” WU stack programming. An asynchronous function is typically a long-running computation and typically marked with the keyword “async.” Async functions provide a mechanism to implement within the traditional programming model a different kind of multitasking, called cooperative multitasking, free from the overheads associated with preemptive multitasking/thread switching and the cost of data locking.

Async functions can be compiled differently from regular functions and generally cannot be executed by simply calling them from regular functions. Execution of async functions in some implementations can be orchestrated by a language runtime component called the executor. An async function can call another async function, which also represents a long-running computation, and wait for the callee to finish execution. Such a call to another long-running computation, with the necessary wait for it to complete, can also be called an “await point”. Generally, in the execution of an async function, only one thread is involved—the one running the executor that orchestrates execution of the async function, including nested async functions. All the async functions “driven” by the executor run in the context of that one thread. Therefore, as far as the CPU is concerned, the async functions are one program that runs continuously, without the overheads associated with thread switching. Furthermore, because an async function is guaranteed not to be interrupted between await points designated in the async function, any complex data update happening between two await points does not require data locking, thus avoiding overheads associated with locking.

In some implementations, an async function can be implemented as a state machine represented as a data structure holding the execution state and an implementation function (e.g., a “poll( )” function). The function implements the logic of the async function such that it can be executed in “chunks” between defined await points. After each chunk, the poll( ) function returns a status code indicating whether the underlying async function finished executing (“Ready” status) or more polling is required (“Pending” status). Repeated calls to the poll( ) function can be made by the executor. After performing a poll( ) function and receiving the “Pending” status code, the executor may choose not to call it again immediately. In some implementations, a mechanism may be provided for a long-running computation to notify the executor of its completion. The executor may not poll the function again until such a notification is received. In the meantime, the executor can poll other functions that it is executing.

In its intended usage on the traditional CPU architecture, the async framework provides the ability for a function to exit after calling a long-running operation (typically input/output) and be reentered to continue execution after the operation completes. The present disclosure provides techniques for implementing a custom executor for asynchronous code that uses the exit/reenter ability to, instead of suspending the function as intended, continually drive its execution using the WU stack so that the function is executed in chunks corresponding to DPU work units. This achieves similar results as physically splitting the code into individual WU handlers while having the code retain its original “natural” form. This enables programmers to write code in the manner with which they are familiar, addressing the issue of programmer productivity and resulting in higher software quality.

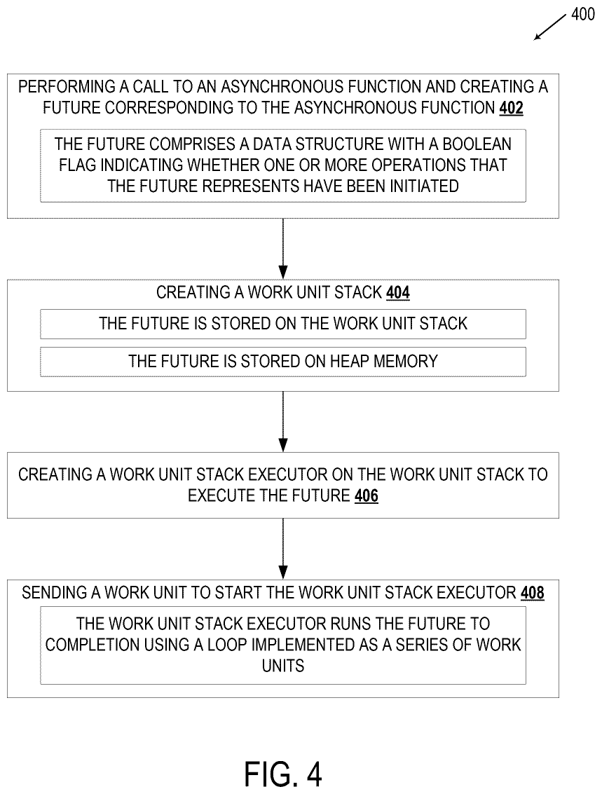

Turning now to FIG. 4, processes for implementing a WU stack executor for adapting an async framework are provided. FIG. 4 shows a flow diagram describing an example method 400 for implementing a WU stack executor capable of executing an async function on a DPU. The techniques described herein can be implemented for various programming languages, including but not limited to the Rust programming language.

The method 400 includes, at step 402, calling an async function and creating a future corresponding to the async function. Execution of an async function in accordance with the example method 400 can be performed in various ways. In some implementations, the async function is implemented as a state machine (which can also be referred to as a “future,” representing computation that will happen in the future when the state machine is “driven” by the executor). More precisely, an async function can be described as a blueprint for creating futures. When an async function is called, a future is created and returned. An async function may be called multiple times, creating multiple futures. In addition to the calling of async functions, futures may be created in other ways. In some implementations, a future is implemented as a programmer-defined data structure created at runtime, along with an associated poll( ) function.

At step 404, the method 400 includes creating a WU stack. The created WU stack can be implemented to manage WUs, including WUs sent by the async function and WUs to run a WU stack executor. WU stacks can be implemented in various ways. In some implementations, a WU stack is implemented as a data structure used by DPU runtime support code to schedule WUs to be sent at a later time and/or to allocate storage that can be used to share data between WU handlers. For example, WU stacks can be implemented in a DPU programming model using the data structure described in FIG. 3.

At step 406, the method 400 includes creating a WU stack executor to execute the future (created in step 402) using the WU stack (created in step 404). In a traditional programming model, callers of a current function and their execution states are recorded using a structure called the execution stack. The execution stack is a central construct in the traditional programming model, and typical CPU architectures provide instructions for management of the execution stack. Programming languages such as C and Rust (in non-async code) can take advantage of those instructions. The execution stack can be used to store the execution state of functions, including the values of their local variables. When a function is called, the storage for its local variables is allocated on the stack. Returning from a function automatically frees that storage. This implements a simple and efficient storage management scheme, and the data associated with a function stays valid for as long as the function is “active”—i.e., for as long as either the function itself or one of the functions it calls is running.

In a DPU programming model, each VP (e.g., processing core of a DPU) executing a WU handler has an active execution stack, referred to herein as a “CPU stack.” In the DPU context, the CPU stack contains data of the current WU handler being executed. Once that WU handler completes, the data on the CPU stack becomes invalid. The CPU stack can be reused across WU handler calls such that the next WU handler running can overwrite the old stack contents.

Naively implementing the traditional future execution scheme as described above in the DPU programming model creates issues. For example, when an async function is called, creating an associated future on a CPU stack associated with a VP of a DPU introduces a problem as the WU stack executor executes futures independently from the originating WU handler. As such, as soon as the WU handler completes, the data on the associated CPU stack may be overwritten by another WU handler while the WU stack executor is still running. To address this issue, the future can be copied to a different memory area allocated and owned by the WU stack executor.

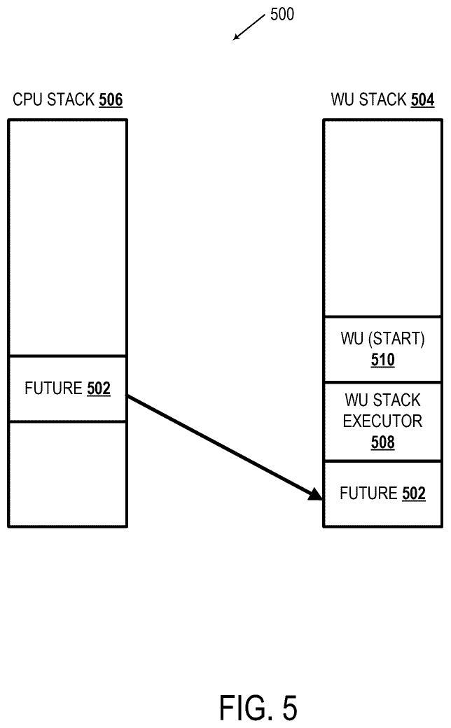

In some implementations, the future is copied to the WU stack of the WU stack executor. FIG. 5 shows a diagram of an example implementation 500 where memory for a future 502 is allocated on a WU stack 504. As shown, the WU stack 504 includes, from bottom to top, a future 502 copied from a CPU stack 506, a WU stack executor 508 referencing the copied future 502, and a WU 510 that, when popped and sent, starts the WU stack executor 508.

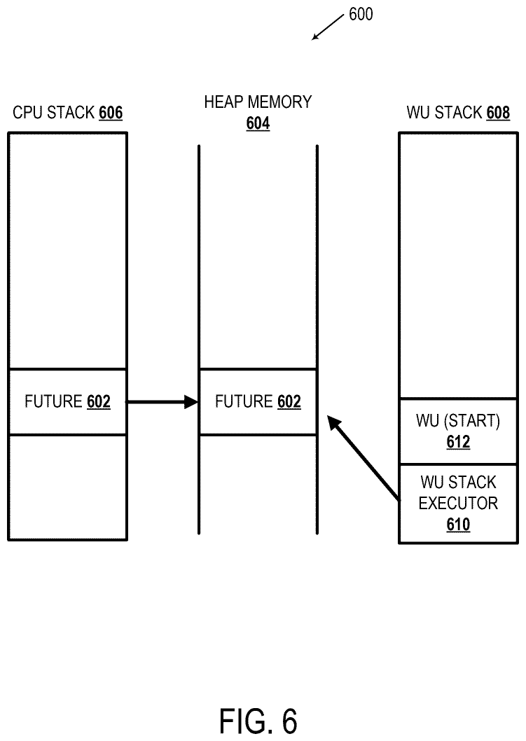

In addition to the implementation shown in FIG. 5, allocation of memory for the future can be performed in various other ways. In some implementations, the future is copied onto heap memory. FIG. 6 shows a diagram of an example implementation 600 where memory for a future 602 is allocated on heap memory 604. As shown, the future 602 is copied from a CPU stack 606 onto the heap memory 604. The WU stack 608 includes a WU stack executor 610 referencing the copied future 602 on the heap memory 604. The WU stack 608 further includes a WU 612 that, when popped and sent, starts the WU stack executor 610.

Different implementations of how the future is allocated can be advantageous depending on the application. Allocating the future to the WU stack is generally faster, and the allocated memory can be freed automatically. However, depending on the size of the future, WU stack allocation and the launch may fail. In comparison, the allocation size limit is much larger on heap memory. Similar to the issue of future allocation, the allocation of storage for the data of the WU stack executor itself is also a consideration. For the same reason as the future, allocating the WU stack executor data on the CPU stack can be problematic. As such, in some implementations, the WU stack executor data is allocated on a WU stack (e.g., its own WU stack), as shown in FIGS. 5 and 6. Any execution-related WUs can be pushed onto the WU stack on top of the data.

Referring back to FIG. 4, at step 408, the method 400 includes sending a WU to start the WU stack executor. With the data structures for the WU stack executor and the future set up as illustrated in, for example, FIGS. 5 and 6, a WU to start the WU stack executor is left on the top of the WU stack. At the end of the setup sequence, the WU can be popped and sent to start the WU stack executor. Depending on the destination of the WU, the WU stack executor may start executing right away concurrently with the launching WU handler (if the destination is a different VP) or be queued for execution at a later time (if the destination is the same VP, or if the destination VP is busy). The execution of the WU handler that contained the launch expression can continue, executing whatever code that followed the launch expression as the execution of the async function by the WU stack executor proceeds independently from the launching WU handler.

In some implementations, the WU stack executor runs a future to completion by using a loop implemented using a series of WUs. In some implementations, the future includes a Boolean status flag that indicates whether the operation it represents has already been initiated. For example, the scheme can include setting the status flag to “false” initially. If the status flag is false when polled, a WU or a series of WUs required to perform the operation is pushed onto the WU stack, the status flag is set to “true,” and a “Pending” status is returned. If the status flag is true when polled, it indicates that the WUs required to perform the operation have already been pushed and executed, and a “Ready” status is returned.

The WU handler can be implemented to run once for each cycle of the WU stack executor (e.g., once for each time the poll( ) function of the related future is called). The first iteration of the loop can be invoked by, for example, sending a WU such as described in step 408 of FIG. 4. The remaining logic for the loop WU handler can be implemented in various ways. If the execution is complete as indicated by a status code in the WU stack executor, return immediately. Otherwise, a WU is pushed onto the WU stack for the next loop iteration, and a call to the poll( ) function of the future is performed. If the poll( ) function returns a “Ready” value, which indicates that the future has completed, the WU stack executor status can be marked as completed.

The executable code of an async function of a future, and any other function it calls, can run within a poll( ) function call. Some of those functions may invoke operations in the DPU runtime which require sending a WU (e.g., memory allocation). In some implementations, such operations are accessed through wrapper async functions. For example, the operation can be made available to user code as a function that explicitly returns a future. The function does not need to be declared as async, but it can behave as such as it can explicitly returns a future and can be called as an async function from other async functions.

An execution of an example async function “my_example( )” performed with an executor loop is now described. The my_example( ) function includes a call to a function “malloc( )” that returns a future “MallocFuture” followed by an await operator, establishing an await point. In such implementations, when the poll( ) function of the future implementing my_example reaches the await point of the malloc( ) call, it calls the poll( ) function of MallocFuture produced by the malloc( ) function.

The first iteration of the executor loop can be initiated by pushing a send of itself onto the WU stack that, when sent (e.g., as described in step 408 of FIG. 4), can start the executor loop. The WU handler checks the executor completion status (which would be incomplete at this point) and pushes a WU for the next loop iteration onto the WU stack. It then calls the poll( ) function of the my_example future.

The poll( ) function executes the code of my_example from the beginning and through the malloc( ) call, which creates a MallocFuture. Then the poll( ) function of MallocFuture is called. The MallocFuture data structure includes a “.requested” flag that is set to false. In this first invocation, the false value of the .requested flag indicates that the allocation has not yet been requested. The poll( ) function of MallocFuture is defined such that the function pushes a malloc WU onto the WU stack, sets the .requested flag to true, and returns the Pending value. The poll( ) function of my_example also returns the Pending value. The execution of the loop WU handler is now complete, and the WU stack has two WUs: the loop WU and the malloc WU on top of it. The arrangement of WUs on the WU stack is such that the WU (or a series of WUs) required to perform the work is on top of a WU that invokes the next iteration of the executor loop (e.g., the loop WU), enabling a loop execution scheme. This arrangement effectively implements a notification scheme to inform the executor of the completion of work performed by the future.

Once the WU or series of WUs pushed by the future is popped off the stack and executed, the executor loop WU below them is popped and executed, serving as a notification to the executor that it is time to poll the future again. For example, because the malloc WU is the topmost, it is popped and sent. The associated WU handler is then executed when available, performing the allocation and storing the result into the specified storage location (e.g., in a “.pointer” field of the MallocFuture). When the malloc handler completes, it pops and sends the top WU now on the WU stack, which is the executor loop WU. When the loop handler runs, the executor status is still not complete. Thus, the handler pushes a WU for the next loop iteration onto the WU stack. It then calls the poll( ) function of the my_example future.

The poll( ) function restarts from its last action, which was the attempt to poll the MallocFuture. The poll( ) function of the MallocFuture is called again. This time, the .requested flag of the MallocFuture is true (as described above). The poll( ) function returns the “Ready( )” response with the pointer stored in its .pointer field by the malloc WU handler. The poll( ) function of my_example receives the Ready( ) response and uses the pointer it contains in the remainder of the my_example body. Assuming the remainder does not perform any more operations that require sending WUs, a Ready( ) response is returned by the poll( ) function of my_example after it reaches the end of the function body. The WU handler now sets the executor status as complete and returns. The WU stack at this point contains a WU for the next loop iteration, which is popped and sent. When this WU is delivered and the loop WU handler is invoked again, the executor status is complete. The handler exits without pushing or sending anything. Execution is now finished, and no further WUs are sent.

In some embodiments, the methods and processes described herein may be tied to a computing system of one or more computing devices. In particular, such methods and processes may be implemented as a computer-application program or service, an application-programming interface (API), a library, and/or other computer-program product.

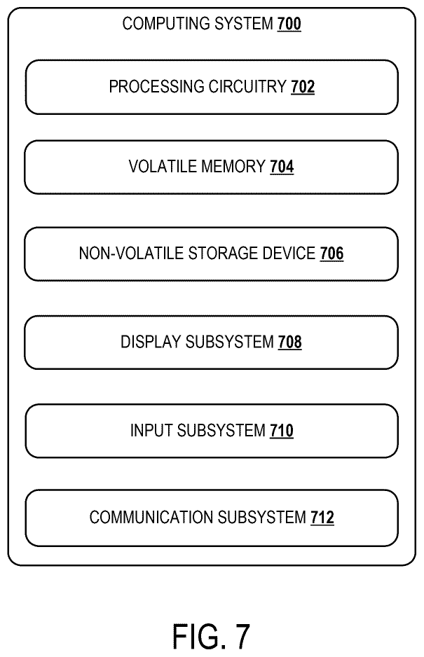

FIG. 7 schematically shows a non-limiting embodiment of a computing system 700 that can enact one or more of the methods and processes described above. Computing system 700 is shown in simplified form. Components of computing system 700 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 700 includes a logic processor 702 volatile memory 704, and a non-volatile storage device 706. Computing system 700 may optionally include a display subsystem 708, input subsystem 710, communication subsystem 712, and/or other components not shown in FIG. 7.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 706 may be transformed e.g., to hold different data.

Non-volatile storage device 706 may include physical devices that are removable and/or built in. Non-volatile storage device 706 may include optical memory, semiconductor memory, and/or magnetic memory, or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included, input subsystem 710 may comprise or interface with one or more user-input devices such as a keyboard, mouse, touch screen, camera, or microphone.

When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 700 to send and/or receive messages to and/or from other devices via a network such as the Internet.

The following paragraphs provide additional description of the subject matter of the present disclosure. One aspect provides a computing system for executing asynchronous functions using a work unit (WU) stack executor, the computing system comprising: a data processing unit including a plurality of programmable processing cores configured to execute an asynchronous function by: performing a call to the asynchronous function; creating a future corresponding to the asynchronous function; creating a WU stack; creating the WU stack executor on the WU stack to execute the future; and sending a WU to start the WU stack executor. In this aspect, additionally or alternatively, the WU stack stores and manages WUs sent by the asynchronous function and WUs to run the WU stack executor. In this aspect, additionally or alternatively, the WU stack executor runs the future to completion using a loop implemented using a series of WUs. In this aspect, additionally or alternatively, each iteration of the loop is performed in response to a call to a poll( ) function of the future. In this aspect, additionally or alternatively, the future comprises a data structure with a Boolean flag indicating whether one or more operations that the future represents have been initiated. In this aspect, additionally or alternatively, when a value of the Boolean flag of the future indicates that the one or more operations have not been initiated, calling a poll( ) function of the future pushes one or more WUs onto the WU stack. In this aspect, additionally or alternatively, when a value of the Boolean flag of the future indicates that the one or more operations have not been initiated, calling a poll( ) function of the future sets the Boolean flag to indicate that the one or more operations have been initiated. In this aspect, additionally or alternatively, the future is stored on the WU stack or on heap memory. In this aspect, additionally or alternatively, the asynchronous function is executed by a single processing core of the plurality of programmable processing cores.

Another aspect provides a method enacted on a data processing unit for executing asynchronous functions using a work unit (WU) stack executor, the method comprising: performing a call to an asynchronous function; creating a future corresponding to the asynchronous function; creating a WU stack; creating the WU stack executor on the WU stack to execute the future; and sending a WU to start the WU stack executor. In this aspect, additionally or alternatively, the WU stack stores and manages WUs sent by the asynchronous function and WUs to run the WU stack executor. In this aspect, additionally or alternatively, the WU stack executor runs the future to completion using a loop implemented using a series of WUs. In this aspect, additionally or alternatively, each iteration of the loop is performed in response to a call to a poll( ) function of the future. In this aspect, additionally or alternatively, the future comprises a data structure with a Boolean flag indicating whether one or more operations that the future represents have been initiated. In this aspect, additionally or alternatively, when a value of the Boolean flag of the future indicates that the one or more operations have not been initiated, calling a poll( ) function of the future pushes one or more WUs onto the WU stack. In this aspect, additionally or alternatively, when a value of the Boolean flag of the future indicates that the one or more operations have not been initiated, calling a poll( ) function of the future sets the Boolean flag to indicate that the one or more operations have been initiated. In this aspect, additionally or alternatively, the future is stored on the WU stack or on heap memory.

Another aspect provides a method enacted on a data processing unit for executing asynchronous functions using a work unit (WU) stack executor, the method comprising: performing a call to an asynchronous function; creating a future corresponding to the asynchronous function; creating a WU stack; creating the WU stack executor on the WU stack to execute the future; sending a WU to start the WU stack executor; upon determining that a WU stack executor status is not complete, pushing a loop WU for performing a next loop iteration onto the WU stack; calling a poll( ) function of the future; and upon determining that the poll( ) function returns a ready status, setting the WU stack executor status as complete. In this aspect, additionally or alternatively, the method further comprises: pushing one or more work units associated with one or more operations of the future onto the WU stack, sending and executing the one or more work units associated with the one or more operations of the future; and sending and executing the loop WU. In this aspect, additionally or alternatively, the future is stored on the WU stack or on heap memory.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for executing asynchronous functions using a work unit (WU) stack executor, the computing system comprising:
a data processing unit including a plurality of programmable processing cores configured to execute an asynchronous function by:
performing a call to the asynchronous function;
creating a future corresponding to the asynchronous function;
creating a WU stack;
creating the WU stack executor on the WU stack to execute the future; and
sending a WU to start the WU stack executor.

2. The computing system of claim 1, wherein the WU stack stores and manages WUs sent by the asynchronous function and WUs to run the WU stack executor.

3. The computing system of claim 1, wherein the WU stack executor runs the future to completion using a loop implemented using a series of WUs.

4. The computing system of claim 3, wherein each iteration of the loop is performed in response to a call to a poll( ) function of the future.

5. The computing system of claim 1, wherein the future comprises a data structure with a Boolean flag indicating whether one or more operations that the future represents have been initiated.

6. The computing system of claim 5, wherein when a value of the Boolean flag of the future indicates that the one or more operations have not been initiated, calling a poll( ) function of the future pushes one or more WUs onto the WU stack.

7. The computing system of claim 5, wherein when a value of the Boolean flag of the future indicates that the one or more operations have not been initiated, calling a poll( ) function of the future sets the Boolean flag to indicate that the one or more operations have been initiated.

8. The computing system of claim 1, wherein the future is stored on the WU stack or on heap memory.

9. The computing system of claim 1, wherein the asynchronous function is executed by a single processing core of the plurality of programmable processing cores.

10. Enacted on a data processing unit, a method for executing asynchronous functions using a work unit (WU) stack executor, the method comprising:
performing a call to an asynchronous function;
creating a future corresponding to the asynchronous function;
creating a WU stack;
creating the WU stack executor on the WU stack to execute the future; and
sending a WU to start the WU stack executor.

11. The method of claim 10, wherein the WU stack stores and manages WUs sent by the asynchronous function and WUs to run the WU stack executor.

12. The method of claim 10, wherein the WU stack executor runs the future to completion using a loop implemented using a series of WUs.

13. The method of claim 12, wherein each iteration of the loop is performed in response to a call to a poll( ) function of the future.

14. The method of claim 10, wherein the future comprises a data structure with a Boolean flag indicating whether one or more operations that the future represents have been initiated.

15. The method of claim 14, wherein when a value of the Boolean flag of the future indicates that the one or more operations have not been initiated, calling a poll( ) function of the future pushes one or more WUs onto the WU stack.

16. The method of claim 14, wherein when a value of the Boolean flag of the future indicates that the one or more operations have not been initiated, calling a poll( ) function of the future sets the Boolean flag to indicate that the one or more operations have been initiated.

17. The method of claim 10, wherein the future is stored on the WU stack or on heap memory.

18. Enacted on a data processing unit, a method for executing asynchronous functions using a work unit (WU) stack executor, the method comprising:
performing a call to an asynchronous function;
creating a future corresponding to the asynchronous function;
creating a WU stack;
creating the WU stack executor on the WU stack to execute the future;
sending a WU to start the WU stack executor;
upon determining that a WU stack executor status is not complete, pushing a loop WU for performing a next loop iteration onto the WU stack;
calling a poll( ) function of the future; and
upon determining that the poll( ) function returns a ready status, setting the WU stack executor status as complete.

19. The method of claim 18, further comprising:
pushing one or more work units associated with one or more operations of the future onto the WU stack,
sending and executing the one or more work units associated with the one or more operations of the future; and
sending and executing the loop WU.

20. The method of claim 18, wherein the future is stored on the WU stack or on heap memory.
